(19) United States
(12) Patent Application Publication
(10) Pub. No.: US 2018/0077958 A1
(43) Pub. Date: Mar. 22, 2018

(54) METHOD FOR MANUFACTURING ALLULOSE-CONTAINING SWEETENER COMPOSITION

(71) Applicant: MATSUTANI CHEMICAL INDUSTRY CO., LTD., Hyogo (JP)

(72) Inventors: Kensaku SHIMADA, Hyogo (JP); Pushpa Kiran GULLAPALLI, Hyogo (JP); Tomoya SHINTANI, Hyogo (JP); Seizo TAKAOKA, Hyogo (JP)

(73) Assignee: MATSUTANI CHEMICAL INDUSTRY CO., LTD., Hyogo (JP)

(21) Appl. No.: 15/561,539

(22) PCT Filed: Mar. 18, 2016
(86) PCT No.: PCT/JP2016/058876

§ 371 Date: Sep. 26, 2017

(30) Foreign Application Priority Data
Mar. 26, 2015 (JP) 2015-065265

(51) Int. Cl. A23L 27/30

(52) U.S. Cl. CPC A23L 27/33; A23V 2002/00; C12Y 501/03; C12Y 503/01005

(57) ABSTRACT

The purpose of the present invention is to provide a technology whereby, in a method for manufacturing a sweetener composition containing glucose, fructose and allulose, said method comprising treating glucose with glucose isomerase and allulose epimerase, the content of allulose in the sweetener composition is increased. A sweetener composition containing glucose, fructose and allulose and having a high allulose content can be continuously manufactured at a high efficiency by immobilizing glucose isomerase and allulose epimerase, packing the same into a column so as to give an activity ratio of the immobilized glucose isomerase to the immobilized allulose epimerase of 1.49:1-5.61:1, and then passing a glucose solution through the column.

### TECHNICAL FIELD

The present invention relates to a method for enzymatically manufacturing a sweetener composition containing glucose, fructose and allulose using glucose as a raw material. More specifically, the present invention relates to a method for efficiently manufacturing a sweetener composition containing glucose, fructose and allulose and having a high allulose content using glucose as a raw material and also using glucose isomerase and allulose epimerase.

### BACKGROUND ART

An isomerized sugar is a sweetener mainly composed of glucose and fructose, and is manufactured by hydrolyzing gelatinized starch with an enzyme to form a glucose solution and allowing glucose isomerase to act on the glucose solution (isomerization reaction). The isomerization reaction by glucose isomerase is an equilibrium reaction, and the content of fructose in the resulting isomerized sugar is usually 46% to 42%. Furthermore, in order to solve the lack of sweetness of an isomerized sugar, refined fructose (which is obtained by separating fructose contained in the isomerized sugar described above by chromatography to increase the purity to about 95%) may be added in some cases, and the content of fructose in the isomerized sugar after the addition is usually about 55%.

Isomerized sugars are widely used in large quantities as a sweetener in soft drinks and other beverages due to their low production cost. The consumption of isomerized sugars is, for example, about 1 million tons per year in Japan and about 8 million tons per year in the United States. Isomerized sugars, however, are suspected as a cause of hyperglycemia, overweight (obesity), metabolic syndrome, and the like in developed countries including Japan and the United States (Non-Patent Document 1). This is because metabolism of fructose in the liver is more likely to promote lipogenesis than glucose does, and tends to induce hyperlipidemia and obesity.

Meanwhile, allulose that is produced by allowing D-ketohexose 3-epimerase (Patent Document 1) to act on fructose is a kind of rare sugar also called psicose. Allulose has been reported to be useful in that it has an energy value of zero (Non-Patent Document 2) and that it has an effect of suppressing postprandial elevation of blood glucose levels (Non-Patent Document 3) and an anti-obesity effect (Non-Patent Document 4), and has been attracting attention as a lifestyle-related disease prevention material. Therefore, a sweetener composition containing allulose and an isomerized sugar in combination is expected to be capable of reducing the above-mentioned risks of isomerized sugars.

In the conventional method for manufacturing allulose, however, fructose refined in advance by chromatographic separation from an isomerized sugar is used as a starting material. Thus, the production process is complicated, the raw material cost, reaction cost, and plant operation cost are high, and efficient industrial production of allulose is difficult.

Therefore, as a method for simply manufacturing a sweetener composition containing allulose and an isomerized sugar in combination, a method of allowing glucose isomerase and D-ketohexose 3-epimerase to act on glucose has been proposed. For example, Non-Patent Document 5 and Patent Document 2 disclose that a sweetener containing glucose, fructose and allulose can be manufactured by simultaneously or sequentially allowing non-immobilized glucose isomerase, immobilized glucose isomerase or immobilized glucose isomerase cells and immobilized D-ketohexose 3-epimerase or non-immobilized D-ketohexose 3-epimerase to act on a glucose solution. Although the batch type manufacture disclosed in Non-Patent Document 5 and Patent Document 2 can increase the content rate of allulose, the method is disadvantageous in that the content rate of allulose is reduced in continuous manufacture.

In addition, Patent Document 3 discloses a method for manufacturing psicose from glucose using an immobilized enzyme and immobilized glucose isomerase, the immobilized enzyme including a recombinant microorganism that has activity of psicose epimerase derived from Agrobacterium tumefaciens and is immobilized on alginic acid. In Patent Document 3, however, only glucose concentration and reaction temperature are studied as control factors for increasing the content rate of psicose, and other control factors are not studied. In addition, in Patent Document 3, the immobilized glucose isomerase and the recombinant microorganism that has psicose epimerase activity and is immobilized on an alginate are packed and used in separate columns. This reflects that it is difficult to homogeneously pack and use both the immobilized enzymes in one column and also difficult to control the enzymatic reaction when the enzymes are packed in one column, because the physical properties of the enzymes are different from each other.

### PRIOR ART DOCUMENTS

### Non-Patent Documents

Non-Patent Document 1: Am. J. Clin. Nutr., 79, 774-779, 2004.
Non-Patent Document 2: J. Nutri. Sci. Vitaminol., 48, 77-80, 2002.
Non-Patent Document 3: J. Nutri. Sci. Vitaminol., 54, 511-514, 2008.
Non-Patent Document 4: Int. J. food Sci. Nutri., 65, 245-250, 2014.
Non-Patent Document 5: J. Ferment. Bioeng., 80, 101-103, 1995.

### PATENT DOCUMENTS

Patent Document 1: Japanese Patent Laid-open Publication No. 6-125776
Patent Document 2: WO 2008/142860
Patent Document 3: Japanese Translation of PCT International Application Publication No. 2013-501519

### DISCLOSURE OF THE INVENTION

### Problems to be Solved by the Invention

The present inventors found that allulose inhibits the isomerization reaction of glucose to fructose caused by glucose isomerase. In order to obtain a sweetener composition high in the content rate of allulose by allowing glucose isomerase and allulose epimerase to act on glucose, it is essential to minimize the influence of the inhibition.

Under such circumstances, an object of the present invention is to provide, in a method for manufacturing a sweetener composition containing glucose, fructose and allulose by allowing glucose isomerase and allulose epimerase to act on glucose, a technique for increasing the content rate of allulose in the sweetener composition.

### Means for Solving the Problems

The present inventors conducted intensive studies to solve the above-mentioned problems and as a result, found that a sweetener composition containing glucose, fructose and allulose and having a high allulose content rate can be continuously and efficiently manufactured by immobilizing glucose isomerase and allulose epimerase, packing the immobilized glucose isomerase and the immobilized allulose epimerase into a column so that the activity ratio between them is 1.49:1 to 5.61:1, and then passing a glucose solution through the column. The present inventors also found that in the manufacture under such conditions, the content rate of allulose in the sweetener composition can be more efficiently increased by setting the space velocity of the glucose solution when being passed through the column to 0.2 to 1.0. The present invention has been accomplished by further studies based on such findings.

That is, the present invention provides the following aspects.

Item 1. A method for manufacturing a sweetener composition containing glucose, fructose and allulose, the method including:

1) a step A of preparing a column packed with immobilized glucose isomerase and immobilized allulose epimerase so that an activity ratio between them is 1.49:1 to 5.61:1;

2) a step B of passing a glucose solution through the column to perform an enzymatic reaction; and

3) a step C of collecting an outflow liquid from the column.

Item 2. The manufacturing method according to item 1, wherein in step B, the glucose solution is passed with space velocity being set to 0.2 to 1.0.

Item 3. The manufacturing method according to item 1 or 2, wherein the immobilized glucose isomerase has a specific activity of 100 U/ml or more.

Item 4. The manufacturing method according to any one of items 1 to 3, wherein the immobilized allulose epimerase has a specific activity of 20 U/ml or more.

Item 5. The manufacturing method according to any one of items 1 to 4, wherein an immobilization carrier of the immobilized allulose epimerase is a polystyrene-based weakly basic anion exchange resin.

Item 6. The manufacturing method according to any one of items 1 to 5, wherein the glucose solution further contains a water-soluble magnesium salt.

Item 7. The manufacturing method according to any one of items 1 to 6, including:

a separation step of further separating the outflow liquid obtained in step C into a glucose/fructose mixture-containing fraction and an allulose-containing fraction; and

a mixing step of mixing the allulose-containing fraction obtained in the separation step with the outflow liquid obtained in step C.

Item 8. A method for simultaneously manufacturing an isomerized sugar product and an allulose product, the method including:

a first step of carrying out the manufacturing method according to any one of items 1 to 6; and

a second step of further subjecting a sweetener composition obtained in first step to a separation treatment of separating the sweetener composition into a glucose/fructose mixture-containing fraction and an allulose-containing fraction.

### Advantages of the Invention

According to the present invention, it is possible to continuously manufacture a sweetener composition containing glucose, fructose and allulose and having a high allulose content rate by a simple technique of passing a glucose solution through a predetermined column. In addition, according to one aspect of the present invention, a sweetener composition having an allulose content rate of about 13% or more can be efficiently manufactured, so that it is also possible to inexpensively provide a sweetener composition which can serve as a lifestyle-related disease prevention material targeted for effects such as zero calorie, suppression of postprandial elevation of blood glucose levels, and anti-obesity. Furthermore, according to one aspect of the present invention, a sweetener composition having a content ratio among glucose, fructose and allulose of 50:37:13 to 43:42:15 can be obtained, so that an existing isomerized sugar product and a high purity allulose product can be obtained simultaneously by a simple technique of subjecting the sweetener composition to a separation treatment to fractionate the composition into a glucose/fructose-containing fraction and an allulose-containing fraction.

Furthermore, the manufacturing method of the present invention can be carried out by a simple technique of passing a glucose solution through a column packed with an immobilized enzyme, and existing isomerized sugar equipment can be used as it is. Thus, the manufacturing method also has an advantage that the burden of capital investment is extremely small.

### BRIEF DESCRIPTION OF THE DRAWINGS

FIG. 1 shows a result of subjecting an outflow liquid obtained in Test No. 6 of Example 2 to chromatographic fractionation and measuring the amounts of glucose, fructose and allulose contained in the fractions.

### EMBODIMENTS OF THE INVENTION

The manufacturing method of the present invention is a method for manufacturing a sweetener composition containing glucose, fructose and allulose, the method including: 1) a step A of preparing a column packed with immobilized glucose isomerase and immobilized allulose epimerase so that an enzymatic activity ratio between them is 1.49:1 to 5.61:1; 2) a step B of passing a glucose solution through the column to perform an enzymatic reaction; and 3) a step C of collecting a fraction containing glucose, fructose and allulose from an outflow liquid from the column. Hereinafter, the manufacturing method of the present invention will be described in detail.

### Definitions

As used herein, the “enzymatic activity (U) of glucose isomerase” means an enzymatic power, and one unit of enzymatic activity is an enzymatic power for producing 1 μmol of fructose per minute when glucose as a substrate is reacted at a reaction temperature of 55° C. Specifically, 2500 μl of a solution of 0.2 M glucose in a 50 mM phosphate buffer (pH 8.0) containing 2 mM magnesium sulfate, 2167 μl of a 50 mM phosphate buffer (pH 8.0) containing 2 mM magnesium sulfate, and 333 μl of glucose isomerase are placed in a screw cap-equipped test tube, immersed in a warm water bath, and reacted at 55° C. for 15 minutes. The pH is adjusted to 3.0 to 2.5 by the addition of a 5% by mass aqueous solution of hydrochloric acid to inactivate the enzyme, and then desalting with an ion exchange resin, filtration with a filter, and HPLC analysis are carried out. The enzymatic activity is calculated using the peak area ratio of the produced fructose.

As used herein, the “enzymatic activity (U) of allulose epimerase” means an enzymatic power, and one unit of enzymatic activity is an enzymatic power for producing 1 μmol of fructose per minute when allulose as a substrate is reacted at a reaction temperature of 55° C. The specific measuring procedure is the same as for the enzymatic activity of glucose isomerase described above, except that the substrate is allulose.

As used herein, the “specific activity (U/ml) of immobilized glucose isomerase” is a value measured according to the method for measuring the maximum activity described in “JIS K7002-1988 Glucose Isomerase for Industrial Use”. Specifically, a 45% by mass glucose solution adjusted to pH 7.8 to 8.0 is prepared by the addition of 2 mM magnesium sulfate and sodium carbonate. Immobilized glucose isomerase (30 ml) swollen at 4° C. for one day and night is weighed, and 100 ml of the glucose solution is added thereto. The mixture is immersed in a warm water bath, and deaerated for 30 minutes or more while being kept at 50° C. under reduced pressure. The mixture is packed into a jacketed glass column having an inner diameter of 20 mm and a length of 400 mm, and then the glucose solution is passed through the column at a jacket temperature of 55° C. in a downward flow using a liquid feeding pump. The outflow liquid is collected, and part of the outflow liquid is desalted with an ion exchange resin, filtered with a filter, and subjected to HPLC analysis, and the isomerization rate is determined from the peak area ratio of the produced fructose. At this time, the flow velocity is set so that the isomerization rate falls within the range of 0.39 to 0.44. Then, the specific activity of immobilized glucose isomerase is determined by the following equation.

E=(FS/W)0.50 ln(0.50/0.50−X)

E: Specific activity (U/ml)

F: Flow velocity (ml/min)

S: Glucose concentration (μmol/ml) in glucose solution

W: Volume (ml) of immobilized glucose isomerase

X: Isomerization rate

As used herein, the “specific activity (U/ml) of immobilized allulose epimerase” is a value measured according to the method for measuring the enzymatic activity of immobilized glucose isomerase except that fructose is used instead of glucose. Specifically, a 45% by mass fructose solution adjusted to pH 7.8 to 8.0 is prepared by the addition of 2 mM magnesium sulfate and sodium carbonate. Immobilized allulose epimerase (30 ml) swollen at 4° C. for one day and night is weighed, and 100 ml of the fructose solution is added thereto. The mixture is immersed in a warm water bath, and deaerated for 30 minutes or more while being kept at 50° C. under reduced pressure. The mixture is packed into a jacketed glass column having an inner diameter of 20 mm and a length of 400 mm, and then the fructose solution is passed through the column at a jacket temperature of 55° C. in a downward flow using a liquid feeding pump. The outflow liquid is collected, and part of the outflow liquid is desalted with an ion exchange resin, filtered with a filter, and subjected to HPLC analysis, and the isomerization rate is determined from the peak area ratio of the produced allulose. At this time, the flow velocity is set so that the isomerization rate falls within the range of 0.21 to 0.24. Then, the specific activity of immobilized allulose epimerase is determined by the following equation.

E=(FS/W)0.27 ln(0.27/0.27−X)

E: Specific activity (U/ml)

F: Flow velocity (ml/min)

S: Fructose concentration (μmol/ml) in fructose solution

W: Volume (ml) of immobilized allulose epimerase

X: Isomerization rate

As used herein, the content rate of each saccharide (glucose, fructose and allulose) in the sweetener composition means the rate (%) of the mass of each saccharide in the total mass (100%) of glucose, fructose and allulose.

As used herein, the “space velocity (SV)” is a unit of the velocity of a solution passed through a column, and is calculated by “space velocity (SV)=amount of liquid passed (ml)/column capacity (ml)/time (h)”.

Step A

In step A, a column packed with immobilized glucose isomerase and immobilized allulose epimerase so that the activity ratio between them is 1.49:1 to 5.61:1 is prepared.

(Immobilized Glucose Isomerase)

Glucose isomerase is an enzyme capable of catalyzing the interconversion between D-glucose and D-fructose. The origin of glucose isomerase used in the present invention is not particularly limited, and the glucose isomerase may be derived from any of microorganisms, animals, plants, and the like. Examples of the microorganism from which glucose isomerase may be derived include Bacillus coagulans, Streptomyces griseofuscus, Streptomyces rubiginosus, and Streptomyces murinus. The glucose isomerase used in the present invention may be isolated from the above-mentioned organism or may be a recombinant produced by a genetic engineering technique. Non-immobilized glucose isomerase is commercially available from, for example, Dow Chemical Company. In the present invention, commercially available glucose isomerase may be immobilized and used.

Further, in the present invention, as the immobilized glucose isomerase, purified or roughly purified and immobilized glucose isomerase may be used, or an immobilized glucose isomerase-producing microorganism may be used.

The immobilization carrier used for immobilization of glucose isomerase is not particularly limited, as far as the enzyme can be immobilized on the carrier. Examples of the carrier include organic polymeric carriers such as ion exchange resins, polyvinyl alcohol, polypropylene, acrylic, chitosan, hydrophobic adsorbent resins, chelate resins and synthetic adsorbent resins; and inorganic carriers such as celite, diatomaceous earth, kaolinite, silica gel, molecular sieves, porous glass, activated carbon, and ceramics. When a microorganism is used as an enzyme to be immobilized, a quaternized pyridine compound (for example, trade name: DAC manufactured by Denki Kagaku Kogyo Co., Ltd.) or an alginate can be used as an immobilization carrier. These immobilization carriers may be used singly or in combination of two or more thereof. Among these, the immobilization carrier is preferably an ion exchange resin, more preferably a weakly basic anion exchange resin, further preferably a polystyrene-based weakly basic anion exchange resin from the viewpoint of maintaining activity of glucose isomerase by immobilization, inexpensiveness, low pressure loss, and ease of handling.

Immobilized glucose isomerase can be obtained by immobilizing glucose isomerase or a microorganism capable of producing glucose isomerase on an immobilization carrier by a known technique. For example, glucose isomerase can be immobilized using an ion exchange resin as an immobilization carrier according to the following procedure. An ion exchange resin is packed into a column and washed with a 50 mM phosphate buffer (pH 8.0) containing 2 mM magnesium sulfate, and then a glucose isomerase solution diluted with a 50 mM phosphate buffer (pH 8.0) containing 2 mM magnesium sulfate to a predetermined concentration is adsorbed to the resin under circulation for about 1 to 16 hours. Then, the resultant is washed with a 50 mM phosphate buffer (pH 8.0) containing 2 mM magnesium sulfate to give immobilized glucose isomerase. Further, after being immobilized as described above, the glucose isomerase may be optionally crosslinked with glutaraldehyde, polyethyleneimine, or the like to enhance the immobilization.

The specific activity of the immobilized glucose isomerase may be appropriately set within a range in which the enzymatic activity ratio of immobilized glucose isomerase to immobilized allulose epimerase described later is satisfied. From the viewpoint of further increasing the content rate of allulose in the sweetener composition to be manufactured, the specific activity is 100 U/ml or more, preferably 100 to 150 U/ml, more preferably 100 to 200 U/ml. In particular, when the specific activity of the immobilized glucose isomerase satisfies the above-mentioned range and further the space velocity at the time of passing the glucose solution in step B is set within the range described later, the content rate of allulose in the sweetener composition to be manufactured is 13% or more, and a sweetener composition having a content ratio among glucose, fructose and allulose of 50:37:13 to 43:42:15 can be efficiently manufactured.

(Immobilized Allulose Epimerase)

Allulose epimerase is an enzyme capable of catalyzing the interconversion between D-fructose and allulose. The origin of allulose epimerase used in the present invention is not particularly limited, and the allulose epimerase may be derived from any of microorganisms, animals, plants, and the like. For example, it is known that allulose epimerase is produced by Arthrobacter globiformis strain M30 (Deposition No. NITE BP-1111). In the present invention, allulose epimerase derived from the microorganism can be used. Examples of the microorganism from which allulose epimerase may be derived include Pseudomonas cichorii, Agrobacterium tumefaciens, Clostridium sp, Clostridium scindens, Clostridium bolteae, Ruminococcus sp, and Clostridium cellulolyticum. The allulose epimerase used in the present invention may be isolated from the above-mentioned organism or may be a recombinant produced by a genetic engineering technique.

Further, in the present invention, as the immobilized allulose epimerase, purified or roughly purified and immobilized allulose epimerase may be used, or an immobilized allulose epimerase-producing microorganism may be used.

The immobilization carrier used for immobilization of allulose epimerase is not particularly limited, as far as the enzyme can be immobilized on the carrier. Examples of the carrier include organic polymeric carriers such as ion exchange resins, polyvinyl alcohol, polypropylene, acrylic, chitosan, hydrophobic adsorbent resins, chelate resins and synthetic adsorbent resins; and inorganic carriers such as celite, diatomaceous earth, kaolinite, silica gel, molecular sieves, porous glass, activated carbon, and ceramics. When a microorganism is used as an enzyme to be immobilized, a quaternized pyridine compound (for example, trade name: DAC manufactured by Denki Kagaku Kogyo Co., Ltd.) or an alginate can be used as an immobilization carrier. These immobilization carriers may be used singly or in combination of two or more thereof. Among these, the immobilization carrier is preferably an ion exchange resin, more preferably a weakly basic anion exchange resin, further preferably a polystyrene divinylbenzene-based weakly basic anion exchange resin from the viewpoint of maintaining activity of allulose epimerase by immobilization, inexpensiveness, low pressure loss, and ease of handling. As an ion exchange group of the weakly basic anion exchange resin, for example, a tertiary amine can be mentioned.

Immobilized allulose epimerase can be obtained by immobilizing allulose epimerase or a microorganism capable of producing allulose epimerase on an immobilization carrier by a known technique. For example, allulose epimerase derived from Arthrobacter globiformis can be immobilized using an ion exchange resin as an immobilization carrier according to the following procedure. First, Arthrobacter globiformis is inoculated into a minimal salts medium (MSM medium) containing 0.5% D-allulose and cultured. Cells are collected from the resulting broth by centrifugation and washed with a 50 mM phosphate buffer (pH 8.0). Next, the washed cells are suspended in a 50 mM phosphate buffer (pH 8.0), about 10% by weight of lysozyme and about 5% by weight of sodium chloride, both based on the weight of wet cells, are added to the suspension, and an extraction reaction of the enzyme is carried out by heating at 37° C. for about 120 minutes. Then, the resultant is further heated at 55° C. for about 15 minutes to inactivate the non-thermostable enzyme, and the centrifugation supernatant is collected as a crude enzyme solution. Separately, an ion exchange resin is packed into a column and washed with a 50 mM phosphate buffer (pH 8.0) containing 2 mM magnesium sulfate, and then the crude enzyme solution diluted with a 50 mM phosphate buffer (pH 8.0) containing 2 mM magnesium sulfate is passed through the ion exchange resin under circulation for about 1 to 16 hours to adsorb the enzyme to the ion exchange resin. Then, the resultant is washed with a 50 mM phosphate buffer (pH 8.0) containing 2 mM magnesium sulfate to give immobilized allulose epimerase. Further, after being immobilized as described above, the allulose epimerase may be optionally crosslinked with glutaraldehyde, polyethyleneimine, or the like to enhance the immobilization.

The specific activity of the immobilized allulose epimerase may be appropriately set within a range in which the enzymatic activity ratio of immobilized glucose isomerase to immobilized allulose epimerase described later is satisfied. From the viewpoint of further increasing the content rate of allulose in the sweetener composition to be manufactured, the specific activity is 20 U/ml or more, preferably 20 to 150 U/ml, more preferably 25 to 80 U/ml. In particular, when the specific activity of the immobilized allulose epimerase satisfies the above-mentioned range and further the space velocity at the time of passing the glucose solution in step B is set within the range described later, the content rate of allulose in the sweetener composition to be manufactured is 13% or more, and a sweetener composition having a content ratio among glucose, fructose and allulose of 50:37:13 to 43:42:15 can be efficiently manufactured.

(Packing of Immobilized Glucose Isomerase and Immobilized Allulose Epimerase into Column)

In the present invention, glucose isomerase and allulose epimerase may be immobilized on different immobilization carriers and packed into one column as a mixture of immobilized glucose isomerase and immobilized allulose epimerase, or both glucose isomerase and allulose epimerase may be immobilized on one immobilization carrier and packed into a column.

In the present invention, both immobilized glucose isomerase and immobilized allulose epimerase are packed into one column so that the activity ratio of immobilized glucose isomerase:immobilized allulose epimerase (specific activity of immobilized glucose isomerase:specific activity of immobilized allulose epimerase) is 1.49:1 to 5.61:1. Combination use of immobilized glucose isomerase and immobilized allulose epimerase at such a ratio makes it possible to efficiently manufacture a sweetener composition having a high content rate of allulose. When the activity ratio of immobilized glucose isomerase to immobilized allulose epimerase is out of the above-mentioned range, the content rate of allulose in the sweetener composition to be manufactured decreases, and the space velocity at the time of passing the glucose solution has to be extremely lowered in order to increase the content rate of allulose. Thus, it becomes impossible to efficiently manufacture a sweetener composition having a high content rate of allulose.

From the viewpoint of more efficiently manufacturing a sweetener composition having a high content rate of allulose, the activity ratio of immobilized glucose isomerase:immobilized allulose epimerase is preferably 2.94:1 to 3.74:1.

Step B

In step B, a glucose solution is passed through the column to perform an enzymatic reaction. By passing a glucose solution through the column, part of glucose undergoes the action of glucose isomerase to be reversibly converted to fructose, and part of the produced fructose undergoes the action of allulose epimerase to be reversibly converted to allulose. The manufacturing method of the present invention enables efficient manufacture of a sweetener containing glucose, fructose and allulose since the enzymatic reactions by glucose isomerase and allulose epimerase proceed reversibly and continuously in one column.

(Glucose Solution)

The glucose solution is a solution of glucose as a substrate dissolved in water. The origin of glucose used in the glucose solution is not particularly limited, and glucose obtained by enzymatic hydrolysis and purification of starch can be mentioned, for example.

The glucose concentration of the glucose solution may be appropriately set according to the desired saccharide concentration and the like of the sweetener composition to be manufactured. The glucose concentration in terms of the Brix concentration is usually 30 to 50%, preferably 35 to 45% from the viewpoint of efficiently manufacturing a sweetener composition having a high content rate of allulose.

In addition, the glucose solution may contain a water-soluble magnesium salt. The incorporation of a water-soluble magnesium salt enables the stabilization of allulose epimerase. The water-soluble magnesium salt to be added to the glucose solution is not particularly limited as far as it is acceptable for food production, and examples thereof include magnesium sulfate and magnesium chloride. These water-soluble magnesium salts may be used singly or in combination of two or more thereof.

The content of the water-soluble magnesium salt in the glucose solution is not particularly limited, and may be, for example, 1 to 5 mM, preferably 1.5 to 2.5 mM.

The pH of the glucose solution may be appropriately set within a range in which immobilized glucose isomerase and immobilized allulose epimerase can exert action, and is usually 7.0 to 8.5, preferably 7.8 to 8.0. The pH of the glucose solution can be adjusted using a known pH adjuster.

(Passage Conditions of Glucose Solution)

The passage conditions of the glucose solution through the column may be appropriately adjusted according to the specific activity of the immobilized enzyme packed in the column, the desired content rate of allulose in the sweetener composition to be manufactured, and the like. The space velocity (SV) of the glucose solution to be passed is 0.2 to 1.0, preferably 0.3 to 0.5 from the viewpoint of more effectively increasing the content rates of fructose and allulose in the sweetener composition to be manufactured.

In particular, when the specific activities of the immobilized glucose isomerase and immobilized allulose epimerase satisfy the above-mentioned ranges and the space velocity (SV) of the glucose solution to be passed satisfies the above-mentioned range, the content rates of fructose and allulose in the sweetener composition to be manufactured are 37% or more and 13% or more, respectively, and a sweetener composition having a content ratio among glucose, fructose and allulose of 50:37:13 to 43:42:15 can be efficiently manufactured. When the content rate of fructose in the sweetener composition to be manufactured is less than 37%, the composition ratio of the sweetener composition differs from those of existing isomerized sugar products and the sweetener composition can no longer be used as an isomerized sugar product as it is, and a further separation treatment or the like may be required. In addition, when the content rate of allulose in the sweetener composition to be manufactured is less than 13%, the composition ratios of glucose and fructose lower the added value of the sweetener composition to be manufactured, and addition of allulose may be separately required.

In addition, when the space velocity is set to a value higher than the above-mentioned range, the production amount per unit time increases. When the space velocity is too high, however, the content rates of fructose and allulose tend to decrease. On the contrary, when the space velocity is set to a value lower than the above-mentioned range, the production amount per unit time decreases, and the manufacturing efficiency tends to decrease. That is, in the manufacturing method of the present invention, controlling the space velocity of the glucose solution to be passed through the column within the above-mentioned range makes it possible to use the sweetener composition to be manufactured as it is as an isomerized sugar product, efficiently incorporate allulose of high value in a high content, and increase the production amount of the sweetener composition per unit time.

The temperature condition at the time of passing the glucose solution through the column may be appropriately set within a range in which the immobilized enzyme packed in the column can exert action, and, for example, the temperature in the column is 45 to 65° C., preferably 55 to 60° C. For adjusting the temperature in the column, for example, a method of warming the column using an insulating jacket can be mentioned.

Step C and Subsequent Steps

In step C, an outflow liquid from the column is collected. The collected outflow liquid contains glucose, fructose and allulose, and can be used as it is as a sweetener composition. In addition, when the content rate of allulose in the outflow liquid is 13 to 15%, the outflow liquid can be used as it is as a low-calorie sweetener composition having low risk of inducing hyperglycemia, overweight (obesity), metabolic syndrome, and the like.

Further, the outflow liquid collected in step C may be optionally concentrated to increase the concentration of the contained saccharide.

Furthermore, the outflow liquid collected in step C may be subjected to a separation treatment such as simulated moving bed chromatography to separately collect a glucose/fructose mixture-containing fraction and an allulose-containing fraction. The allulose-containing fraction thus obtained has a purity of allulose of 90% or more, and can be used as a lifestyle-related disease prevention material targeted for zero calorie, suppression of postprandial elevation of blood glucose levels, anti-obesity, and the like. In addition, a glucose/fructose mixture-containing fraction can be used as it is as an existing isomerized sugar product (glucose:fructose=58:42 to 50:50, weight ratio).

It is also possible to obtain a sweetener composition having an even higher content rate of allulose by adding the allulose-containing fraction to the outflow liquid collected in step C. A sweetener composition having an increased content rate of allulose can be used as a low-calorie sweetener with enhanced allulose function.

### EXAMPLES

Hereinafter, the present invention will be described in more detail with reference to examples, but the present invention is not limited thereto. In the following, the expression “ratio of specific activity (I:E)” means “specific activity of immobilized glucose isomerase:specific activity of immobilized allulose epimerase”. The expressions “activity ratio”, “enzymatic activity ratio” and “ratio of enzymatic activity” are synonymous with the above.

### Production Example 1

Preparation and activity measurement of immobilized enzymes Commercially available immobilized glucose isomerase was obtained from Nagase ChemteX Corporation (trade name: Suitase GN). This product was a granular preparation including a microorganism having glucose isomerase activity immobilized on a carrier, and had a specific activity of 110.43 U/ml after being swollen.

When independently preparing immobilized glucose isomerase, the procedure was as follows. First, 50 ml of an ion exchange resin (trade name: PUROLITE A103S manufactured by Purolite) was packed into a column and washed with a 50 mM phosphate buffer (pH 8.0) containing 2 mM magnesium sulfate, and 500 ml of a 2 mM magnesium sulfate-containing 50 mM phosphate buffer (pH 8.0) containing 4500U of liquid glucose isomerase (trade name: Spezyme Gifp manufactured by The Dow Chemical Company) was passed through the ion exchange resin under circulation at 4° C. for 16 hours to adsorb the glucose isomerase to the ion exchange resin. Then, the resultant was washed with a 50 mM phosphate buffer (pH 8.0) containing 2 mM magnesium sulfate to give immobilized glucose isomerase. The immobilized glucose isomerase thus obtained had a specific activity of 107.65 U/ml.

The immobilized allulose epimerase was prepared by the method shown in the following (1) to (3).

(1) Cell culture and collection of cells: Arthrobacter globiformis M30 was inoculated into 4 L of a minimal salts medium (MSM medium) containing 0.5% allulose and cultured at 30° C. for 24 hours at a stirring speed of 400 rpm and an aeration rate of 0.10 L per L medium/min using ajar fermenter. From the broth, 100 g (wet weight) of the cells were collected by centrifugation and washed with a 50 mM phosphate buffer (pH 8.0).

(2) Step of extracting crude enzyme: Of the obtained cells, 100 g (wet weight) of the cells were suspended in 1000 ml of a 50 mM phosphate buffer (pH 8.0), 10 g of egg white lysozyme (food additive, manufactured by Kewpie Corporation) and 5 g of sodium chloride were added to the suspension, and an extraction reaction of the enzyme was carried out by heating at 37° C. for 120 minutes. Then, the resultant was further heated at 55° C. for 15 minutes, and the supernatant obtained by centrifugation (12000 rpm, 30 minutes) was used as a crude enzyme solution.

(3) Immobilization of crude enzyme: A wet ion exchange resin (50 ml, trade name: PUROLITE A103S manufactured by Purolite) was packed into a column and washed with a 50 mM phosphate buffer (pH 8.0) containing 2 mM magnesium sulfate, and 500 ml of a 2 mM magnesium sulfate-containing 50 mM phosphate buffer (pH 8.0) containing 4500 units of D-allulose-3-epimerase was passed through the ion exchange resin under circulation at 4° C. for 16 hours to adsorb the enzyme to the ion exchange resin. The resultant was washed with a 50 mM phosphate buffer (pH 8.0) containing 2 mM magnesium sulfate to give immobilized allulose epimerase. The immobilized allulose epimerase had a specific activity of 29.55 U/ml.

### Example 1

Confirmation of sweetener composition obtained by passing glucose solution through column packed with immobilized glucose isomerase and immobilized allulose epimerase (under condition of space velocity SV=0.2)

Commercially available immobilized glucose isomerase or independently prepared immobilized glucose isomerase and immobilized allulose epimerase, that were prepared in Production Example 1, were homogeneously mixed so that the amounts and activity ratio would be as shown in Table 1, and packed into a jacketed glass column having an inner diameter of 32 mm and a length of 300 mm.

TABLE 1
Activity ratio between two immobilized enzymes mixed

| | | Column | Total enzymatic | Activity |
|---|---|---|---|---|
| Test | | capacity | activity in column | ratio |
| No. | Immobilized enzyme | (ml) | (U) | (I:E) |
| 1 | Commercially available | 100 | 11043 | 3.74:1 |
| | immobilized | | | |
| | glucose isomerase | | | |
| | Immobilized allulose | 100 | 2955 | |
| | epimerase | | | |

A 35% by mass glucose solution adjusted to pH 7.8 to 8.0 was prepared by the addition of 2 mM magnesium sulfate and sodium carbonate. The glucose solution was continuously passed through the column in an upward flow with the jacket temperature and the space velocity (SV) controlled to 50° C. and 0.2, respectively. The outflow liquid was collected three times at 24-hour intervals, and the space velocity SV was obtained from the amount of liquid and the collection time at each collection. Next, part of each collected outflow liquid was subjected to desalting with an ion exchange resin and filtration with a filter, and then subjected to HPLC analysis (analytical column: MCIGEL CK08EC manufactured by Mitsubishi Chemical Corporation). Thus, the peak area ratio among glucose, fructose and allulose was determined and the composition ratio of the reaction product was calculated.

The obtained results are shown in Table 2. As shown in Table 2, the outflow liquid was substantially uniform among different collection times, and the composition ratio (weight ratio) among glucose, fructose and allulose was 43.6:41.3:15.1 to 43.4:41.5:15.1.

TABLE 2
Composition ratio of outflow liquid

| | Enzymatic | | Space | Composition ratio of | | |
|---|---|---|---|---|---|---|
| Test | activity ratio | Time | velocity | reaction product (%) | | |
| No. | (I:E) | (h) | SV | Glucose | Fructose | Allulose |
| 1 | 3.74:1 | 24 | 0.20 | 43.6 | 41.3 | 15.1 |
| | | 48 | 0.20 | 43.4 | 41.5 | 15.1 |
| | | 72 | 0.20 | 43.4 | 41.5 | 15.1 |

### Example 2

Influence of mixing ratio of immobilized glucose isomerase to immobilized allulose epimerase on composition ratio among glucose, fructose and allulose (under condition of space velocity SV=0.3 to 0.4)

Commercially available immobilized glucose isomerase or independently prepared immobilized glucose isomerase and immobilized allulose epimerase, that were prepared in Production Example 1, were homogeneously mixed so that the amounts and activity ratio would be as shown in Table 3, and packed into a jacketed glass column having an inner diameter of 32 mm and a length of 300 mm.

TABLE 3
Activity ratio between two immobilized enzymes mixed

| | | | Total | |
|---|---|---|---|---|
| | | | enzymatic | |
| | | Column | activity | Activity |
| Test | | capacity | in column | ratio |
| No. | Immobilized enzyme | (ml) | (U) | (I:E) |
| 2 | Commercially available immobilized | 40 | 4417 | 0.93:1 |
| | glucose isomerase | | | |
| | Immobilized allulose epimerase | 160 | 4728 | |
| 3 | Commercially available | 50 | 5522 | 1.25:1 |
| | immobilized glucose isomerase | | | |
| | Immobilized allulose epimerase | 150 | 4433 | |
| 4 | Commercially available | 57 | 6295 | 1.49:1 |
| | immobilized glucose isomerase | | | |
| | Immobilized allulose epimerase | 143 | 4226 | |
| 5 | Independently prepared | 67 | 7213 | 1.84:1 |
| | immobilized glucose isomerase | | | |
| | Immobilized allulose epimerase | 133 | 3930 | |
| 6 | Independently prepared | 80 | 8612 | 2.43:1 |
| | immobilized glucose isomerase | | | |
| | Immobilized allulose epimerase | 120 | 3546 | |
| 7 | Commercially available | 100 | 11043 | 3.74:1 |
| | immobilized glucose isomerase | | | |
| | Immobilized allulose epimerase | 100 | 2955 | |
| 8 | Commercially available | 120 | 13252 | 5.61:1 |
| | immobilized glucose isomerase | | | |
| | Immobilized allulose epimerase | 80 | 2364 | |
| 9 | Commercially available | 150 | 16565 | 11.21:1 |
| | immobilized glucose isomerase | | | |
| | Immobilized allulose epimerase | 50 | 1478 | |

A 35% by mass glucose solution adjusted to pH 7.8 to 8.0 was prepared by the addition of 2 mM magnesium sulfate and sodium carbonate. The glucose solution was continuously passed through the column in an upward flow with the jacket temperature and the space velocity (SV) controlled to 50° C. and 0.3 to 0.4, respectively. The outflow liquid was collected three to four times at 24-hour intervals, and the space velocity SV was obtained from the amount of liquid and the collection time at each collection. Next, part of each collected outflow liquid was subjected to desalting with an ion exchange resin and filtration with a filter, and then subjected to HPLC analysis (analytical column: MCIGEL CK08EC manufactured by Mitsubishi Chemical Corporation). Thus, the peak area ratio among glucose, fructose and allulose was determined and the composition ratio of the reaction product was calculated.

The obtained results are shown in Table 4. From these results, when the activity ratio between immobilized glucose isomerase and immobilized allulose epimerase that were packed into the column was in the range of 1.25:1 to 5.61:1, the content rate of allulose in the outflow liquid was high and exceeded 13%. On the other hand, when the activity ratio between immobilized glucose isomerase and immobilized allulose epimerase that were packed into the column was less than 1.25:1 or more than 5.61:1, the content rate of allulose in the outflow liquid did not reach 13%. From these results, it was confirmed that the activity ratio between immobilized glucose isomerase and immobilized allulose epimerase that are to be packed into the column should be set within the range of 1.25:1 to 5.61:1 in order to increase the content rate of allulose in the outflow liquid.

TABLE 4
Activity ratio between two immobilized enzymes
mixed and composition ratio of outflow liquid

| | Ratio of | | | | | |
|---|---|---|---|---|---|---|
| | specific | | Space | Composition ratio of | | |
| Test | activity | Time | velocity | reaction product (%) | | |
| No. | (I:E) | (h) | SV | Glucose | Fructose | Allulose |
| 2 | 0.93:1 | 24 | 0.38 | 58.1 | 31.0 | 10.9 |
| | | 48 | 0.34 | 53.0 | 34.7 | 12.2 |
| | | 72 | 0.34 | 53.0 | 34.7 | 12.2 |
| | | 96 | 0.37 | 52.5 | 35.1 | 12.4 |
| 3 | 1.25:1 | 24 | 0.35 | 49.9 | 37.0 | 13.1 |
| | | 48 | 0.34 | 50.1 | 36.8 | 13.0 |
| | | 72 | 0.34 | 50.1 | 36.8 | 13.0 |
| | | 96 | 0.34 | 50.1 | 36.8 | 13.0 |
| 4 | 1.49:1 | 24 | 0.35 | 49.3 | 37.5 | 13.2 |
| | | 48 | 0.35 | 49.3 | 37.5 | 13.2 |
| | | 72 | 0.35 | 49.3 | 37.9 | 13.3 |
| | | 96 | 0.35 | 49.3 | 38.1 | 13.3 |
| 5 | 1.84:1 | 24 | 0.40 | 49.3 | 37.1 | 13.6 |
| | | 48 | 0.40 | 49.3 | 37.1 | 13.6 |
| | | 72 | 0.40 | 49.3 | 37.1 | 13.6 |
| | | 96 | 0.36 | 48.8 | 37.6 | 13.7 |
| 6 | 2.43:1 | 24 | 0.40 | 48.6 | 37.9 | 13.5 |
| | | 48 | 0.40 | 48.3 | 38.1 | 13.5 |
| | | 72 | 0.40 | 48.4 | 38.0 | 13.6 |
| | | 96 | 0.40 | 48.1 | 38.4 | 13.5 |
| 7 | 3.74:1 | 24 | 0.38 | 46.3 | 39.9 | 13.8 |
| | | 48 | 0.37 | 45.4 | 40.2 | 14.4 |
| | | 72 | 0.36 | 45.2 | 40.3 | 14.5 |
| | | 96 | 0.36 | 45.2 | 40.3 | 14.5 |
| 8 | 5.61:1 | 24 | 0.38 | 45.3 | 41.1 | 13.6 |
| | | 48 | 0.37 | 44.6 | 41.4 | 13.9 |
| | | 72 | 0.36 | 44.3 | 41.5 | 14.1 |
| | | 96 | 0.36 | 44.3 | 41.5 | 14.1 |
| 9 | 11.21:1 | 24 | 0.37 | 45.7 | 41.8 | 12.5 |
| | | 48 | 0.38 | 46.8 | 41.2 | 12.0 |
| | | 72 | 0.38 | 45.4 | 42.3 | 12.3 |

### Example 3

Influence of mixing ratio of immobilized glucose isomerase to immobilized allulose epimerase on ratio among glucose, fructose and allulose (under condition of space velocity SV=0.5)

In order to determine the activity ratio between immobilized enzymes at which the rate of allulose is 13% or more even under the condition of high space velocity SV, the following test was carried out. That is, in this test, conditions of an efficient manufacturing method with high production amount per unit time were verified.

Immobilized glucose isomerase and immobilized allulose epimerase that were prepared in Production Example 1 were homogeneously mixed so that the amounts and activity ratio would be as shown in Table 5, and packed into a jacketed glass column having an inner diameter of 20 mm and a length of 400 mm.

TABLE 5
Activity ratio between two immobilized enzymes mixed

| | | | Total | |
|---|---|---|---|---|
| | | | enzymatic | |
| | | Column | activity | Activity |
| Test | | capacity | in column | ratio |
| No. | Immobilized enzyme | (ml) | (U) | (I:E) |
| 10 | Independently prepared immobilized | 17 | 1877 | 1.84:1 |
| | glucose isomerase | | | |
| | Immobilized allulose epimerase | 33 | 975 | |
| 11 | Independently prepared immobilized | 20 | 2209 | 2.43:1 |
| | glucose isomerase | | | |
| | Immobilized allulose epimerase | 30 | 887 | |
| 12 | Commercially available immobilized | 22 | 2429 | 2.94:1 |
| | glucose isomerase | | | |
| | Immobilized allulose epimerase | 28 | 827 | |
| 13 | Commercially available immobilized | 25 | 2761 | 3.74:1 |
| | glucose isomerase | | | |
| | Immobilized allulose epimerase | 25 | 739 | |
| 14 | Commercially available immobilized | 28 | 3092 | 4.76:1 |
| | glucose isomerase | | | |
| | Immobilized allulose epimerase | 22 | 650 | |
| 15 | Commercially available immobilized | 30 | 3313 | 5.61:1 |
| | glucose isomerase | | | |
| | Immobilized allulose epimerase | 20 | 591 | |

A 35% by mass glucose solution adjusted to pH 7.8 to 8.0 was prepared by the addition of 2 mM magnesium sulfate and sodium carbonate. The glucose solution was continuously passed through the column in an upward flow with the jacket temperature and the space velocity (SV) controlled to 50° C. and 0.5, respectively. The outflow liquid was collected three to four times at 24-hour intervals, and the space velocity SV was obtained from the amount of liquid and the collection time at each collection. Next, part of each collected outflow liquid was subjected to desalting with an ion exchange resin and filtration with a filter, and then subjected to HPLC analysis (analytical column: MCIGEL CK08EC manufactured by Mitsubishi Chemical Corporation). Thus, the peak area ratio among glucose, fructose and allulose was determined and the composition ratio of the reaction product was calculated.

The obtained results are shown in Table 6. From these results, it was clarified that when the activity ratio between immobilized glucose isomerase and immobilized allulose epimerase that are packed into the column is in the range of 2.94:1 to 3.74:1, an outflow liquid having an allulose content rate of 13% or more can be stably obtained even when the space velocity is as high as 0.5.

TABLE 6
Activity ratio between two immobilized enzymes
mixed and composition ratio of outflow liquid

| | Enzymatic | | Loading | Composition ratio of | | |
|---|---|---|---|---|---|---|
| Test | activity ratio | Time | velocity | reaction product (%) | | |
| No. | (I:E) | (h) | SV | Glucose | Fructose | Allulose |
| 10 | 1.84:1 | 24 | 0.50 | 55.3 | 32.9 | 11.8 |
| | | 48 | 0.50 | 55.3 | 32.9 | 11.8 |
| | | 72 | 0.50 | 55.3 | 32.9 | 11.8 |
| | | 96 | 0.50 | 50.2 | 36.5 | 13.3 |
| 11 | 2.43:1 | 24 | 0.50 | 53.7 | 34.6 | 11.6 |
| | | 48 | 0.50 | 53.7 | 34.6 | 11.6 |
| | | 72 | 0.50 | 53.7 | 34.6 | 11.6 |
| | | 96 | 0.50 | 48.8 | 37.8 | 13.4 |
| 12 | 2.94:1 | 24 | 0.50 | 49.9 | 36.8 | 13.3 |
| | | 48 | 0.50 | 49.1 | 37.5 | 13.4 |
| | | 72 | 0.50 | 49.4 | 37.4 | 13.3 |
| 13 | 3.74:1 | 24 | 0.50 | 47.7 | 39.0 | 13.3 |
| | | 48 | 0.50 | 47.0 | 39.5 | 13.4 |
| | | 72 | 0.50 | 47.2 | 39.6 | 13.3 |
| 14 | 4.76:1 | 24 | 0.54 | 47.3 | 39.5 | 13.2 |
| | | 48 | 0.52 | 47.2 | 39.8 | 13.1 |
| | | 72 | 0.53 | 47.4 | 39.8 | 12.8 |
| 15 | 5.61:1 | 24 | 0.54 | 48.0 | 39.1 | 12.9 |
| | | 48 | 0.53 | 47.4 | 39.6 | 13.0 |
| | | 72 | 0.53 | 47.9 | 39.4 | 12.7 |

### Example 4

Simultaneous manufacture of isomerized sugar product and allulose product Into a jacketed glass column having an inner diameter of 42 mm and a length of 500 mm and kept at 60° C., 400 ml of a cation exchange resin for chromatographic separation (trade name: CR1310 manufactured by ORGANO CORPORATION) was compacted and packed, 21.86 g of the outflow liquid (glucose:fructose: allulose composition ratio=45.2:40.3:14.5) obtained in Test No. 7 in Example 2 was injected into the column, and pure water as an eluent was passed through the column at SV=1.5. The eluate after 15 minutes or more from the start of the passage of the eluent was separated and collected in 88 fractions every 30 seconds using a fraction collector. After the solution weight (g) and Brix (%) of each fraction was measured, part of the fraction was filtered with a filter and analyzed by HPLC (analytical column: MCIGEL CK08EC manufactured by Mitsubishi Chemical Corporation). Thus, the peak area ratio among glucose, fructose and allulose was determined and regarded as the composition ratio among the fractions.

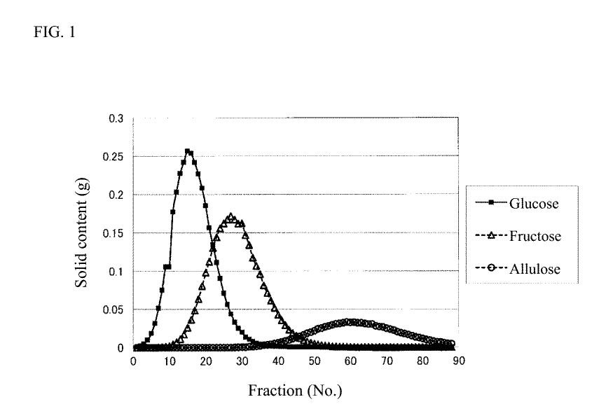

From these measurement results, solid contents (g) of glucose, fructose and allulose eluted in each fraction were calculated. The results are shown in FIG. 1. As is clear from FIG. 1, it was found that when the fractions are separately collected in a former half of fractions 1 to 45 and a latter half of fractions 46 to 88, an isomerized sugar (glucose:fructose:allulose=53.2:45.6:1.2) can be obtained on the former fractions 1 to 45 side, and allulose having a purity of 91.5% (glucose:fructose:allulose=1.5:7.0:91.5) can be obtained on the latter fractions 46 to 88 side. That is, from these results, it was revealed that an isomerized sugar product and an allulose product can be simultaneously manufactured by fractionating the outflow liquid obtained in Examples 1 to 3 using an ion exchange resin.

1. A method for manufacturing a sweetener composition comprising glucose, fructose and allulose, the method comprising:
1) a step A of preparing a column packed with immobilized glucose isomerase and immobilized allulose epimerase so that an activity ratio between them is 1.49:1 to 5.61:1;
2) a step B of passing a glucose solution through the column to perform an enzymatic reaction; and
3) a step C of collecting an outflow liquid from the column.

2. The manufacturing method according to claim 1, wherein in step B, the glucose solution is passed with space velocity being set to 0.2 to 1.0.

3. The manufacturing method according to claim 1, wherein the immobilized glucose isomerase has a specific activity of 100 U/ml or more.

4. The manufacturing method according to claim 1, wherein the immobilized allulose epimerase has a specific activity of 20 U/ml or more.

5. The manufacturing method according to claim 1, wherein an immobilization carrier of the immobilized allulose epimerase is a polystyrene-based weakly basic anion exchange resin.

6. The manufacturing method according to claim 1, wherein the glucose solution further contains a water-soluble magnesium salt.

7. The manufacturing method according to claim 1, comprising:
a separation step of further separating the outflow liquid obtained in step C into a glucose/fructose mixture-containing fraction and an allulose-containing fraction; and
a mixing step of mixing the allulose-containing fraction obtained in the separation step with the outflow liquid obtained in step C.

8. A method for simultaneously manufacturing an isomerized sugar product and an allulose product, the method comprising:
a first step of carrying out the manufacturing method according to claim 1; and
a second step of further subjecting a sweetener composition obtained in first step to a separation treatment of separating the sweetener composition into a glucose/fructose mixture-containing fraction and an allulose-containing fraction.
